(19) United States
(12) Patent Application Publication
(10) Pub. No.: US 2014/0268156 A1
(43) Pub. Date: Sep. 18, 2014

(54) METHOD AND SYSTEM FOR DETERMINING BUBBLE POINT PRESSURE

(71) Applicant: SCHLUMBERGER TECHNOLOGY CORPORATION, (US)

(72) Inventors: ELIZABETH SMYTHE, CAMBRIDGE, MA (US); SHUNSUKE FUKAGAWA, ARLINGTON, MA (US); MATTHEW T. SULLIVAN, WESTWOOD, MA (US); CHRISTOPHER HARRISON, AUBURNDALE, MA (US)

(73) Assignee: SCHLUMBERGER TECHNOLOGY CORPORATION, SUGAR LAND, TX (US)

(21) Appl. No.: 13/800,896

(22) Filed: Mar. 13, 2013

(51) Int. Cl. G01N 21/59

(52) U.S. Cl. CPC G01N 21/59
USPC 356/436

(57) ABSTRACT

Method and systems for determining bubble point pressure of a fluid sample are described herein. The method includes transmitting light through the fluid sample and detecting transmitted light. The method also includes applying a series of thermal pulses to the fluid sample. The series of thermal pulses includes a time interval between each thermal pulse. The pressure of the fluid sample is varied and the bubble point pressure of the fluid sample is determined using an intensity of the transmitted light that corresponds to a time interval between the thermal pulses.

### TECHNICAL FIELD

This disclosure relates to fluid analysis, and more particularly to determining bubble point pressure of a fluid.

### BACKGROUND

A bubble point pressure is the pressure at which at least a portion of a liquid changes phase to a vapor state (e.g., nucleates bubbles) at equilibrium. FIG. 1 shows an oil sample in a liquid state within an enclosed volume. As the size of the enclosed volume is increased, the pressure of the oil sample decreases and bubbles begin to form at the bubble point pressure. In the oil and gas industry, the bubble point pressure of a fluid within a hydrocarbon reservoir formation is valuable information that is used for completing and producing a well. For example, during production of a well, the fluid that is extracted from the hydrocarbon reservoir is maintained above the known bubble point pressure to avoid creation of bubbles within the formation.

Using one technique, bubble point pressure of a fluid sample can be determined by measuring light transmission through the fluid sample while reducing the pressure of the sample. As the pressure within the fluid sample is decreased, at a certain pressure, the light transmission will decrease significantly. The pressure and temperature at which the light transmission will decrease significantly is the bubble point pressure and the bubble point temperature. The decrease in light transmission occurs because bubbles form at the bubble point and the bubbles scatter light, which lowers the amount of light transmission.

In some cases, this technique may confuse the bubble point pressure with asphaltene onset pressure (AOP). Some fluids, such as oils, contain a substantial amount of asphaltenes. Asphaltenes are large molecules that are dissolved within the oil at high pressures. As the pressure of the oil is reduced, the solubility of the asphaltenes within the oil is also reduced and the asphaltenes will begin to flocculate. The pressure at which the asphaltenes begin to flocculate is the asphaltene onset pressure. FIG. 2 shows the process of flocculation. As shown in FIG. 2, individual molecules of asphaltenes form nanoaggregates and then form clusters of nanoaggregates. This flocculation of asphaltenes will also reduce the light transmission of an oil sample. FIG. 3 shows how flocculation of asphaltenes reduces light transmission. As the enclosed volume is increased, the pressure of the oil sample decreases and asphaltenes begin to flocculate at the asphaltene onset pressure. At this point, the oil sample turns opaque and reduces the transmission of light. Because both the bubble point and the asphaltene onset pressure reduce the transmission of light, such an approach to measuring bubble point may confuse the bubble point pressure with the asphaltene onset pressure.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Illustrative embodiments are directed to a method for determining bubble point pressure of a fluid sample. The method includes transmitting light through the fluid sample and detecting transmitted light. The method also includes applying a series of thermal pulses to the fluid sample. The series of thermal pulses includes a time interval between each thermal pulse. The pressure of the fluid sample is varied and the bubble point pressure of the fluid sample is determined using an intensity of the transmitted light that corresponds to a time interval between thermal pulses.

Various embodiments are also directed to a system for determining bubble point pressure of a fluid sample. The system includes a source for generating light that is transmitted through the fluid sample and a detector for detecting light. The system also includes a heating element for applying thermal pulses to the fluid sample and a controller that determines the bubble point of the fluid sample using an intensity of the transmitted light that corresponds to a time interval between thermal pulses.

Further illustrative embodiments are directed to determining asphaltene onset pressure of a fluid sample. The method includes transmitting light through the fluid sample and detecting transmitted light. The method also includes applying a series of thermal pulses to the fluid sample. The pressure of the fluid sample is varied. The asphaltene onset pressure can be determined by identifying a decrease within an intensity of the transmitted light and using an intensity of the transmitted light corresponding to a time interval between thermal pulses to exclude a bubble point transition as a cause of the decrease within the intensity of the transmitted light.

### BRIEF DESCRIPTION OF THE DRAWINGS

Those skilled in the art should more fully appreciate advantages of various embodiments of the present disclosure from the following “Description of Illustrative Embodiments,” discussed with reference to the drawings summarized immediately below.

FIG. 1 shows nucleation of bubbles within an oil sample;

FIG. 2 shows flocculation of asphaltenes;

FIG. 3 shows flocculation of asphaltenes within an oil sample;

FIG. 4 shows a wireline logging system at a well site in accordance with one embodiment of the present disclosure;

FIG. 5 shows a wireline tool in accordance with one embodiment of the present disclosure;

FIG. 6A shows a system for determining bubble point pressure of a fluid sample in accordance with one embodiment of the present disclosure;

FIG. 6B shows another view of the system of FIG. 6A;

FIG. 7 shows a system for determining bubble point pressure of a fluid sample in accordance with another embodiment of the present disclosure;

FIG. 8 shows a method for determining bubble point of a fluid sample in accordance with one embodiment of the present disclosure;

FIG. 9 shows a series of thermal pulses and a corresponding transmitted light signal in accordance with one embodiment of the present disclosure;

FIG. 10 shows a plot of a transmitted light signal as a function of pressure and nucleation of bubbles adjacent to a wire in accordance with one embodiment of the present disclosure;

FIG. 11 shows a plot of a relative light signal, and the corresponding transmitted light signal from the plot in FIG. 10 in accordance with one embodiment of the present disclosure;

FIG. 12 shows a plot of a relative light signal in accordance with one embodiment of the present disclosure;

FIG. 13 shows a more detailed view of the plot of FIG. 12;

FIG. 14 shows a method for determining asphaltene onset pressure (AOP) in accordance with one embodiment of the present disclosure; and

FIG. 15 shows a plot of a transmitted light signal as a function of pressure for a pressure cycling method in accordance with one embodiment of the present disclosure.

### DESCRIPTION OF ILLUSTRATIVE EMBODIMENTS

Illustrative embodiments of the disclosure are directed to a method and system for determining bubble point pressure of a fluid sample, such as an oil sample. The method includes transmitting light through the fluid sample and detecting light that is transmitted through the fluid sample. The method further includes applying a series of thermal pulses to the fluid sample. The series of thermal pulses includes a time interval between each thermal pulse. The behavior of the transmitted light during a time interval after each thermal pulse can be used to identify the bubble point pressure and also to distinguish between the bubble point pressure and an asphaltene onset pressure (AOP). In a particular embodiment, a relative light signal can be determined using (i) an intensity of the transmitted light corresponding to a pulse and (ii) a baseline intensity of the transmitted light corresponding to a time interval. Flocculation of asphaltenes will not affect this relative light signal and the bubble point pressure of the fluid sample can be determined by identifying a change in the relative light signal. Details of various embodiments are discussed below.

FIG. 4 shows one example of a wireline logging system 400 at a well site. Such a wireline logging system 400 can be used to implement a measurement of bubble point pressure, as described herein. In this example, a wireline tool 402 is lowered into a borehole 404 that traverses a formation 406 using a cable 408 and a winch 410. The wireline tool 402 is lowered down into the borehole 404 and makes a number of measurements of the adjacent formation 406 at a plurality of sampling locations along the borehole 404. The data from these measurements is communicated through the cable 408 to surface equipment 412, which may include a computer system for storing and processing the data obtained by the wireline tool 402. In this case, the surface equipment 412 includes a truck that supports the wireline tool 402. In another embodiment, however, the surface equipment may be located within a cabin on an off-shore platform.

FIG. 5 shows a more detailed view of the wireline tool 402. The wireline tool includes 402 a selectively extendable fluid admitting assembly (e.g., probe) 502. This assembly 502 extends into the formation 406 and withdraws formation fluid from the formation 406 (e.g., samples the formation). The fluid flows through the assembly 502 and into a flow line 504 within a housing 506 of the tool 402. A pump (not shown) can be used to withdraw the formation fluid from the formation 406 and pass the fluid through the flow line 504. The wireline tool 402 may also include a selectively extendable tool anchoring member 508 that is arranged to press the probe 502 assembly against the formation 406. The wireline tool 402 also includes a fluid analyzer module 510 for analyzing at least a portion of the fluid in the flow line 504. The fluid analyzer module 510 includes a system for determining bubble point pressure of a fluid sample.

FIGS. 6A and 6B show a more detailed view of a system 600 for determining bubble point pressure of a fluid sample. The system 600 includes a housing 602 that defines a detection chamber 604 for at least partially containing the fluid sample. In various embodiments, the housing 602 is formed from a metal material, such as aluminum. In some embodiments, the detection chamber 604 is a channel that receives a fluid sample that is extracted from the flow line 504 of the wireline tool 402. In yet further embodiments, the channel may be a microfluidic channel that has a diameter of less than 1 mm.

The system 600 also includes a light source 606 for generating light that passes through the fluid sample and a light detector 608 for detecting transmitted light. The light can be of a variety of different wavelengths and can include visible light, infrared light and/or ultraviolet light. In the specific embodiment shown in FIG. 6A, the light source 606 is a tungsten halogen lamp that generates light and provides the light to a first optical fiber 612. A first ball lens 614 serves as both a window preventing outflow of the fluid sample and a lens that collimates the light from the optical fiber 612 into the detection chamber 604. The system 600 also includes a second ball lens 616 that serves as both a window preventing outflow and a lens that focuses the light signal from the detection chamber onto a second optical fiber 618. The second optical fiber 618 provides the transmitted light to a light detector 608, such as a photodiode. The light detector 608 translates the transmitted light into a transmitted light signal that is representative of the intensity of the transmitted light.

The system 600 further includes a heating element 622 for applying thermal pulses to the fluid sample. The heating element 622 is at least partially disposed within the detection chamber 604 so that it can apply thermal energy to the fluid sample. In one specific embodiment, the heating element 622 is a wire that passes orthogonally between the first ball lens 614 and the second ball lens 616 (e.g., passes through a collimated light path 624 between the two lenses 614, 616). The wire 622 can have a diameter of approximately 25 μm and can be made of nickel, chromium, iridium, palladium and/or platinum. In some embodiments, the wire may be a combination of 80 percent Nickel and 20 percent Chromium (Nichrome80). A pulsed electric current is applied to the wire 622. The pulsed current will create thermal energy within the wire 622 that will conduct into the fluid that surrounds the wire. In this manner, the wire 622 generates thermal pulses that enter the fluid sample and raise the temperature of the fluid sample. The rise in temperature within the fluid sample has the potential to produce bubbles within the fluid sample. To improve the performance of the system 600, the layout of the system can be optimized so that the light incident to the detection chamber 604 passes through the detection chamber with maximum optical efficiency and uniformly illuminates a volume around the wire 622 where the bubble nucleation takes place. To this end, fiber-to-lens spacing and location of the wire within the system can be modified appropriately.

In some embodiments, the system 600 also includes a pressure unit 626 for changing the pressure within the fluid sample and a pressure sensor 628 that monitors the pressure of the fluid sample. In one specific embodiment, the pressure unit 626 is a piston that is in communication with the detection chamber 604 and that expands the volume of the fluid sample to decrease the pressure of the sample within the detection chamber. A pressure sensor 628 is used to monitor the actual pressure within the fluid sample. The pressure sensor 628 can be a strain gauge or a resonating pressure gauge.

The system 600 may also include a temperature detector 629, such as a resistive temperature detector (RTD) that is in thermal communication with the fluid sample and measures the temperature of the fluid sample. In one specific embodiment, the temperature detector 629 is in thermal contact with the housing 602 and can measure the temperature of the fluid sample within the detection chamber 604.

The system 600 also includes a controller 630 for controlling the system 600 and processing signals that are received from various components within the system. In particular, in various embodiments, the controller 630 provides the pulsed electric current to the wire 622 so that the series of thermal pulses is applied to the fluid sample. To this end, the controller 630 may include a power supply and an oscillator circuit. The controller 630 may also receive the transmitted light signal that is representative of the intensity of the transmitted light from the light detector 608. The controller 630 may also maintain timing (e.g., synchronization) between the transmitted light signal from the light detector 608 and the pulsed electric current provided to the wire 622 so that corresponding portions between the transmitted light signal and pulsed electric current can be identified. In an asynchronous embodiment, the controller 630 may sample the transmitted light signal at a high sampling rate, such as 100 Hz. In some embodiments, the controller 630 samples the transmitted light signal at a frequency of at least 25 Hz. The controller 630 may use the transmitted light signal to determine a relative light signal. A process for determining a relative light signal is further described below. Furthermore, the controller 630 can also be in electronic communication with the pressure unit 626 and the pressure sensor 628. The controller 630 can modify the pressure within the detection chamber 604 by controlling the pressure unit 626 and also monitor the actual pressure within the sample by interpreting an output pressure signal from the pressure sensor 628. In some embodiments, the controller samples the output pressure signal at a sampling rate of between 10 Hz and 60 Hz.

Illustrative embodiments of the system 600 are not limited to the embodiment shown in FIGS. 6A and 6B. For example, in some embodiments, a flat planar window can serve to prevent outflow of the fluid and a ball lens can be positioned behind the planar window. In another illustrative embodiment, a light emitting diode (LED) is used in place of the tungsten halogen lamp.

FIG. 7 shows another example of a system 700 for determining bubble point pressure of a fluid sample. The system includes a light source 702 that is coupled to a fiber splitter 704 (e.g., a 2×2 fiber splitter). Light that enters each of two input fibers of the fiber splitter 704 is mixed and then split between two output fibers. Then, a first output fiber 706 (e.g., an optical fiber) provides the light to a “phase change” module 708 (e.g. a measurement module), while a second output fiber 710 provides the light to a reference module 712. The phase change module 708 includes a system 701, such as system 600 described with reference to FIGS. 6A and 6B, and also a first set of coupling optics 714 located between the system 701 and a first detector 716. The phase change module 708 is used to detect a phase transition of a fluid sample (e.g., bubble point or asphaltene onset pressure) by measuring transmitted light. The reference module 712 includes a second set of coupling optics 718 and a second detector 720. A phase change output signal from the first detector 716 and a reference output signal from the second detector 720 are provided to a controller 722. The controller converts the signals into voltages and digitizes the signals using an analog-to-digital-conversion. The reference output signal is used to monitor the fluctuation of light source intensity and compensate for effects that appear within the phase change output signal so that a representative signal of the transmitted light can be measured (e.g., a transmitted light signal). For example, if the light source were to become dimmer, then there would be a drop in the transmitted light. The reference output signal could be used to determine whether this drop is due to a phase change within the detection chamber or due to the light source becoming dimmer. The controller 722 also maintains timing (e.g., synchronization) between the output signals from the detectors 716, 720 and the pulsed electric current provided to the wire 622 so that corresponding portions between the output signals and pulsed electric current can be identified. This system 700 configuration provides for detection of faint changes within the transmitted light. In various embodiments, the configuration can detect a change in the intensity of transmitted light with a pulse height on the order of 0.01 percent of the light intensity obtained in an empty detection chamber condition, while also maintaining a sufficient signal-to-noise ratio (e.g., 10).

Further details of devices and systems for determining bubble point pressure are provided in U.S. patent application Ser. No. 13/403,989, filed on Feb. 24, 2012, which is incorporated by reference herein in its entirety.

FIG. 8 shows a method 800 for determining bubble point of a fluid sample. Prior to the first process 802, a fluid sample enters the detection chamber of the system. In one specific embodiment, the fluid sample is a formation fluid sample (e.g., oil sample) that was extracted from a flow line of a borehole tool (e.g., a wireline or logging-while-drilling (LWD) tool), which, in turn, extracted the formation fluid from a location-of-interest within the formation. The method thus begins at process 802, which transmits light through the fluid sample using a light source, and process 804, which detects transmitted light using a light detector.

The method also includes process 806, which applies a series of thermal pulses to the fluid sample using, for example, the wire 622 described in FIGS. 6A and 6B. FIG. 9 shows the series of thermal pulses 902, which also correspond to the pulsed electrical current provided to the wire. In a specific embodiment, each pulse 904 has duration of 10 microseconds. In further embodiments, the pulse duration can have a range between 5 microseconds and 50 microseconds. Accordingly, the pulses 904 are not drawn to scale in FIG. 9. The series also includes a time interval 906 between each thermal pulse 904. In one specific embodiment, this time interval 906 is approximately 1 second (e.g., 1 second minus pulse duration). In various embodiments, the time interval 906 can have a range between 0.1 seconds and 10 seconds. Also, in a specific embodiment, the current pulses that produce the thermal pulses 902 have amplitudes of 10 amps. In illustrative embodiments, thermal pulses 902 have amplitudes between 1 and 50 amps. In further embodiments, the thermal pulses 902 are applied periodically at a time-averaged power level that does not significantly heat the fluid sample. For example, the thermal pulses 902 are applied so that there is no more than a 5 milli-Kelvin increase in temperature within the housing of the system (e.g., measured using a thermistor). To avoid overheating the system, in a specific embodiment, the thermal pulses 902 are applied at a frequency of 1 Hertz with a pulse duration of 10 microseconds, which corresponds to a duty cycle of approximately 10⁻⁵. Such a duty cycle can be used to minimize the transfer of thermal energy into the fluid sample, while also sufficiently heating the sample adjacent to the wire to cause bubbles to nucleate.

Each thermal pulse applied to the sample will have an effect on the intensity of the transmitted light. FIG. 9 shows how a transmitted light signal 908 decreases as each thermal pulse 904 is applied to the sample. The decrease in intensity of the transmitted light can be caused by one or both of two factors. The first factor is that each thermal pulse produces a local variation in the index of refraction of the fluid adjacent to the wire (e.g., a mirage effect). The change in the index of refraction directs light away from the detector and produces a small decrease in intensity of the transmitted light (e.g., 5 percent of a baseline intensity value). In some cases, the change in the index of refraction can cause an increase in the intensity of the transmitted light because the change causes more light to be directed at the detector. The second factor is that, as the pressure of the sample approaches the bubble point pressure, each thermal pulse will cause bubbles to nucleate within the fluid adjacent to the wire. The bubbles will scatter light and produce a large decrease in intensity of the transmitted light. FIG. 10 shows a plot 1000 of a transmitted light signal 1002 as a function of pressure, and also the behavior of the fluid sample adjacent to a wire 1003 corresponding to three different points along the plot 1000. At point 1004 of the plot, the thermal pulse has been applied, bubbles nucleate within a localized area adjacent to the wire 1003, and the intensity of the transmitted light drops (e.g., to a magnitude of 0.30 in FIG. 10). After the pulse ends, at point 1006, the thermal energy within the localized area adjacent to the wire 1003 gradually dissipates so that the bubbles dissolve and the index of refraction returns to its original state. For these reasons, the intensity of the transmitted light also gradually returns to a baseline intensity value (e.g., a magnitude of 0.35 in FIG. 10). This baseline intensity value is represented by point 1008 on the plot 1000. At the bubble point pressure (and below the bubble point pressure), the intensity of the transmitted light will no longer return to the baseline intensity value because the bubbles will no longer dissolve into the fluid.

At process 808, the pressure of the fluid sample is varied by, for example, decreasing the pressure of the fluid sample. This decrease in pressure may be performed incrementally, in steps, and/or continuously. The decrease in pressure also occurs while the system is transmitting light into detection chamber and while the series of thermal pulses is being applied to the fluid sample. Process 808 can be performed by the pressure unit and monitored by the pressure sensor, as described above.

As the pressure unit decreases the pressure within the fluid sample, the fluid sample will eventually reach the bubble point pressure. At the bubble point pressure (and below the bubble point pressure), the intensity of the transmitted light will no longer return to the baseline value because the bubbles will no longer dissolve into the fluid. At process 810, by using a baseline intensity of the transmitted light corresponding to the time interval after a pulse, the method can determine the bubble point pressure of the fluid sample. In particular, by identifying a change, such as a decrease, within the baseline intensity of the transmitted light after each pulse, the method can identify the bubble point pressure of the fluid sample. The change within the baseline intensity of the transmitted light after each pulse can be further identified by comparing the baseline intensity to an intensity of the transmitted light corresponding to a thermal pulse. The baseline intensity can be compared to the intensity of the transmitted light corresponding to a thermal pulse by, for example, subtracting one from the other and/or dividing one by the other (e.g., a ratio).

In a specific embodiment, a relative light signal can be used to identify the bubble point pressure. The relative light signal is determined using (i) the intensity of the transmitted light corresponding to a pulse and (ii) the baseline intensity of the transmitted light corresponding to a time interval. In particular, a baseline intensity of the transmitted light corresponding to an end portion of the time interval is used (or a plurality of end portions). As explained above, the controller maintains timing (e.g., synchronization) between the transmitted light signal from the detector and the pulsed electric current provided to the wire so that corresponding portions between the transmitted light signal and pulsed electric current can be identified. FIG. 9 shows a portion of the transmitted light signal 910 that corresponds to a thermal pulse 904 and a baseline intensity portion 912 that corresponds to an end portion 914 of a time interval 906. In some embodiments, the end portion 914 can have a duration within a range of 1-40 milliseconds. In various embodiments, the baseline intensity portion corresponds to the end portion of the time interval, which occurs at the end of the time interval and before the next thermal pulse is applied. In such embodiments, the baseline intensity is obtained at the end portion of the time interval so that the intensity of the transmitted light signal has time to recover from the prior thermal pulse. In other embodiments, if the time interval is sufficiently long, the baseline intensity can be obtained at a different portion of the time interval (e.g., a central portion). The intensity of the transmitted light corresponding to a pulse can be obtained as the current pulse 904 is being applied. Also, in various embodiments, the intensity of the transmitted light corresponding to a pulse is acquired shortly after the current pulse 904 is applied (e.g., 10 milliseconds after the pulse 904 is applied). The acquisition can be delayed due to the time lag associated with thermal energy entering the fluid sample from the heating element.

As explained above, the relative light signal can be used to identify the pressure at which bubbles no longer dissolve in the fluid sample and, in this manner, identify the bubble point pressure of the fluid sample. In one specific embodiment, the relative light signal can be calculated according to the following equation.

$$Relative Light Signal ( t ) = \frac{I ( Baseline ) - I ( t )}{I ( Baseline )} , \qquad Eq . 1$$

where I(t) is the intensity of the transmitted light at time (t) and I(Baseline) is the baseline intensity of the transmitted light corresponding to the time interval. In one embodiment, the baseline intensity of the transmitted light is obtained from a single light intensity value that corresponds to a single time interval (e.g., a single end portion). For example, the single light intensity value corresponds to an end portion of a time interval that appears immediately after the thermal pulse is applied. In other embodiments, the baseline intensity of the transmitted light is obtained from a plurality of light intensity values that each correspond to a time interval. For example, the baseline intensity of the transmitted light signal can be obtained by averaging two light intensity values. The first light intensity value corresponds to an end portion of a time interval that appears immediately before the thermal pulse is applied, while the second light intensity value corresponds to an end portion of a time interval that appears immediately after the thermal pulse is applied. In yet another example, more than two light intensity values are used to determine the baseline intensity of the transmitted signal.

FIG. 11 shows a plot 1100 of a relative light signal 1102 and the corresponding transmitted light signal 1002 from the plot 1000 in FIG. 10. The relative light signal 1102 was obtained using the relationship in Equation 1. In this example, the magnitude of the relative light signal 1102 is at a maximum when the intensity of the transmitted light is at a minimum. A change in the magnitude in the relative light signal 1102 can be used to identify the bubble point pressure.

Equation 1 is one example of a relationship that can be used to determine a relative light signal. Other relationships can also be used to determine the relative light signal. For example, in one embodiment, the relative light signal is determined using an absolute value of the difference between (i) the baseline intensity of the transmitted light corresponding to the time interval and (ii) the intensity of the transmitted light at time (t), as shown in the following equation.

$$Relative Light Signal ( t ) = \frac{\vert I ( Baseline ) - I ( t ) \vert}{I ( Baseline )} , \qquad Eq . 2$$

In another embodiment, the relative light signal is determined using a ratio of the baseline intensity of the transmitted light corresponding to the time interval and the intensity of the transmitted light at time (t), as shown in the following equation.

$$Relative Light Signal ( t ) = \frac{I ( Baseline )}{I ( t )} , \qquad Eq . 3$$

In a further embodiment, the relative light signal is determined by subtracting the intensity of the transmitted light from the intensity of the transmitted light at time (t), as shown in the following equation.

Relative Light Signal (t)=I(Baseline)−I(t), Eq. 4

Other relationships that use the baseline intensity of the transmitted light corresponding to the time interval to determine a relative light signal are also within the scope of the present disclosure.

The bubble point pressure of the fluid sample can be determined using the relative light signal. As explained above, at the bubble point pressure, the bubbles will no longer dissolve. This behavior will result in a change within the relative light signal. The bubble point of the fluid sample is determined by identifying a change within the relative light signal as the pressure of the fluid sample is decreased. In a particular embodiment, the bubble point of the fluid sample is determined by identifying an increase within the relative light signal as the pressure of the fluid sample is decreased. FIG. 12 shows a plot 1200 of a relative light signal 1202 determined according to Equation 1. FIG. 13 shows a more detailed view of the plot 1200 of FIG. 13. As shown in FIGS. 12 and 13, the relative light signal 1202 remains constant, while the pressure within the sample is decreased. At point 1204, however, the relative light signal 1202 suddenly increases. This sudden increase indicates that the bubble point pressure has been reached and the pressure at which this increase happens is the bubble point pressure. In this example, the bubble point pressure is 2775 psi.

The bubble point pressure is determined for a particular temperature. In many cases, the bubble point is a function of both the pressure of the fluid sample and the temperature of the fluid sample. The temperature at which the bubble point occurs can be measured by a temperature detector, such as the temperature detector 629 shown in FIG. 6A.

The bubble point pressure can be confirmed by identifying a change within the transmitted light that corresponds in pressure to the change in the relative light signal. In particular, the bubble point of the fluid sample is confirmed by identifying a decrease within the transmitted light that corresponds to an increase in the relative light signal. FIGS. 12 and 13 also show a transmitted light signal 1206, which represents the intensity of the light signal received at the detector. At point 1204, the relative light signal 1202 increases and, at the same pressure, the transmitted light signal 1206 decreases at point 1208. This simultaneous change in the relative light signal 1202 and the transmitted light signal 1206 confirms the bubble point pressure.

The relative light signal can also be used to distinguish between bubble point pressure and asphaltene onset pressure because the flocculation of asphaltenes will not significantly impact the relative light signal. In FIGS. 12 and 13, as the pressure is lowered, the transmitted light signal 1206 is relatively constant. Specifically, as the pressure is decreased, the transmitted light signal slowly increases due to a decrease in the density of the fluid sample. At point 1210, however, the transmitted light signal 1206 decreases suddenly. This decrease in the transmitted light signal 1206 at point 1210 happens because the asphaltenes within the fluid sample begin to flocculate (e.g., at approximately 5000 psi) and the flocculated asphaltenes reduce light transmission through the sample. As shown in FIG. 12, the flocculation of asphaltenes will not significantly impact the relative light signal 1202. At the asphaltene onset pressure, the relative light signal 1202 remains constant.

By distinguishing between bubble point pressure and asphaltene onset pressure, the method described herein can also be used to determine the asphaltene onset pressure of the fluid sample. The asphaltene onset pressure can be determined by identifying a decrease within transmitted light and a corresponding constant relative light signal. FIGS. 12 and 13 show one way the asphaltene onset pressure can be determined. At point 1210, the transmitted light signal 1206 decreases while the relative light signal 1202 remains constant. This behavior of the transmitted light signal 1206 and the relative light signal 1202 at point 1210 indicates that the asphaltene onset pressure has been reached. The pressure that corresponds to point 1210 is the asphaltene onset pressure (e.g., at approximately 5000 psi).

Various embodiments of the present disclosure are also directed to a method for determining asphaltene onset pressure of a fluid sample. The method can be implemented by the systems described above (e.g., system 600 and system 700). FIG. 14 shows one example of a method 1400 for determining asphaltene onset pressure of a fluid sample. The method 1400 includes transmitting light through the fluid sample 1402, detecting transmitted light 1404, applying a series of thermal pulses to the fluid sample 1406 and varying pressure of the fluid sample 1408. The method 1400 also includes identifying a decrease within the transmitted light 1410. For example, the transmitted light signal 1206 shown within FIG. 12 includes two such decreases within the transmitted light represented by points 1208 and 1210.

At process 1412, the method determines whether a bubble point transition is a cause of the decrease within the transmitted light signal. In particular, the process 1412 uses a baseline intensity of the transmitted light corresponding to a time interval between the thermal pulses to exclude a bubble point transition as a cause of the decrease within the intensity of the transmitted light. If the bubble point transition is not the cause of the decrease within the transmitted light (e.g., the bubble point transition is excluded as a cause), then the decrease within the transmitted light represents the asphaltene onset pressure. In a specific embodiment, the cause of the decrease within the transmitted light can determined by analyzing a relative light signal, such as a relative light signal determined according to Equation 1 above. If the relative light signal corresponding to the decrease within the transmitted light is constant, then a bubble point transition is not the cause of the decrease within the transmitted light and the decrease is representative of the asphaltene onset pressure. For example, at point 1210, the corresponding relative light signal 1202 is constant and, thus, point 1210 of the transmitted light signal is representative of the asphaltene onset pressure. On the other hand, at point 1208, the corresponding relative light signal 1202 increases and this increase indicates that point 1208 is not representative of the asphaltene onset pressure.

Various embodiments of the present disclosure are also directed to determining upper and lower bounds for asphaltene onset pressure. In some cases, the asphaltene onset pressure can be difficult to determine due to kinetic barriers within the fluid sample. In one embodiment, such kinetic barriers are overcome by actively mixing the fluid sample. Without mixing, asphaltene onset will occur within the fluid sample, but it may occur below an actual thermodynamic asphaltene onset pressure, which may lead to a significant underestimate of the actual asphaltene onset pressure. To address this problem, the systems and methods described herein can be used to determine upper and lower bounds for asphaltene onset pressure. The upper and lower bounds provide a basic understanding of the fluid sample and its behavior at various pressures.

In some embodiments, a pressure cycling method is used to determine upper and lower bounds for asphaltene onset pressure. In a particular embodiment, this method is applied when the fluid sample is disposed in a microfluidic channel. FIG. 15 shows a plot 1500 of a transmitted light signal as a function of pressure for a pressure cycling method. The pressure cycling method includes decreasing pressure within the fluid sample to determine a lower boundary for asphaltene onset pressure 1502. This “depressurization” portion of the method can be implemented as shown in FIG. 14. Once a lower bound for the asphaltene onset pressure is determined 1502, the pressure within the fluid sample is increased to determine an upper boundary for asphaltene onset pressure. While the fluid sample is below the asphaltene onset pressure, the fluid sample will transmit less light during pressurization than the sample did during depressurization, resulting in a lower recorded transmitted light signal. In equilibrium and above the asphaltene onset pressure, the transmitted light signal will return to its value during depressurization. In FIG. 15, this point is represented by reference number 1504. This point represents the upper bound for asphaltene onset pressure. In this manner, the pressure cycling method provides a lower and upper boundary for asphaltene onset pressure. In some cases, as explained above, kinetic barriers may delay the recovery of the transmitted light signal to a pressure above the lower bound of the asphaltene onset pressure. Also, the upper bound of the asphaltene onset pressure may depend on the behavior of the fluid sample and also the rate of pressurization.

Some of the processes described herein, such as (1) determining bubble point pressure of a fluid sample, (2) determining asphaltene onset pressure of a fluid sample, (3) providing a pulsed electric current to a wire, (4) interpreting an output pressure signal from a pressure sensor, (5) controlling a pressure unit, (6) receiving a transmitted light signal from a detector, (7) determining a relative light signal, (8) identifying a change within a relative light signal, (9) identifying a change within a transmitted light signal, and (10) obtaining light intensity values corresponding to portions of a pulsed electric current (e.g., synchronization), can be performed by the controller.

In one specific embodiment, the controller is located within the borehole tool along with the system for determining bubble point pressure. In such an embodiment, processes 1-10 can be performed within the borehole tool. In another embodiment, the controller is located at the surface as part of the surface equipment (e.g., the truck 412 in FIG. 4) and some or all of processes (1)-(10) are performed at the surface by the surface equipment. In yet another embodiment, a first controller is included within the borehole tool and a second controller is located at the surface as part of the surface equipment. In this embodiment, the processes (1)-(10) can be split between the two controllers. In yet another embodiment, some of processes (1)-(10) are performed at a location that is remote from the well site, such as an office building or a laboratory.

The term “controller” should not be construed to limit the embodiments disclosed herein to any particular device type or system. The controller may include a computer system. The computer system may also include a computer processor (e.g., a microprocessor, microcontroller, digital signal processor, or general purpose computer) for executing any of the methods and processes described above (e.g. processes (1)-(10)).

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. This memory may be used to store, for example, data from transmitted light signals, relative light signals, and output pressure signals.

Some of the methods and processes described above, including processes (1)-(10), as listed above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the controller may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

Illustrative embodiments of the present disclosure are not limited to wireline logging operations, such as the ones shown in FIGS. 1 and 2. For example, the embodiments described herein can also be used with any suitable means of conveyance, such coiled tubing. Furthermore, various embodiments of the present disclosure may also be applied in logging-while-drilling (LWD) operations, sampling-while-drilling operations, measuring-while-drilling operations, or any other operation where sampling of the formation is performed.

Also, the methods and systems described herein are not limited to analyzing a set of particular fluids. Various embodiments of methods and systems described herein can be used to analyze hydrocarbons (e.g., dark oils, heavy oils, volatile oils, and black oils).

Furthermore, various embodiments of the present disclosure are not limited to oil and gas field applications. The methods and systems described herein can also be applied to, for example, petrochemical refining and chemical manufacturing.

Although several example embodiments have been described in detail above, those skilled in the art will readily appreciate that many modifications are possible in the example embodiments without materially departing from the scope of this disclosure. Accordingly, all such modifications are intended to be included within the scope of this disclosure.

What is claimed is:

1. A method for determining bubble point pressure of a fluid sample, the method comprising:
transmitting light through the fluid sample;
applying a series of thermal pulses to the fluid sample, wherein the series comprises a time interval between each thermal pulse;
detecting transmitted light;
varying pressure of the fluid sample; and
determining the bubble point pressure of the fluid sample using an intensity of the transmitted light corresponding to at least one time interval.

2. The method of claim 1, further comprising:
distinguishing between the bubble point and asphaltene onset pressure using the intensity of the transmitted light corresponding to the at least one time interval.

3. The method of claim 1, wherein determining the bubble point of the fluid sample further comprises:
determining a relative light signal using (i) an intensity of the transmitted light corresponding to at least one pulse and (ii) the intensity of the transmitted light corresponding to the at least one time interval; and
using the relative light signal to determine the bubble point pressure.

4. The method of claim 3, wherein the relative light signal is determined according to:
$$Relative Light Signal ( t ) = \frac{I ( Baseline ) - I ( t )}{I ( Baseline )} ,$$
wherein I(t) is the intensity of the transmitted light at time t and I(Baseline) is the intensity of the transmitted light corresponding to the at least one time interval.

5. The method of claim 3, wherein the bubble point of the fluid sample is determined by identifying a change within the relative light signal as the pressure of the fluid sample is decreased.

6. The method of claim 5, wherein the bubble point of the fluid sample is determined by identifying an increase within the relative light signal as the pressure of the fluid sample is decreased.

7. The method of claim 6, wherein determining the bubble point of the fluid sample further comprises identifying a corresponding decrease within the intensity of the transmitted light as the pressure of the fluid sample is decreased.

8. The method of claim 1, wherein the intensity of the transmitted light corresponding to at least one time interval is determined using a plurality of intensities each corresponding to a time interval.

9. The method of claim 1, wherein the intensity of the transmitted light corresponds to an end portion of the at least one time interval.

10. The method of claim 3, further comprising:
determining an asphaltene onset pressure for the fluid sample by identifying a decrease within an intensity of the transmitted light and a corresponding constant relative light signal.

11. A system for determining bubble point of a fluid sample, the system comprising:
a source for generating light that is transmitted through the fluid sample;
a detector for detecting light;
a heating element for applying thermal pulses to the fluid sample; and
a controller configured to determine the bubble point of the fluid sample using an intensity of the transmitted light corresponding to at least one time interval between thermal pulses.

12. The system of claim 11, wherein the controller is configured to determine a relative light signal using (i) an intensity of the transmitted light corresponding to at least one pulse and (ii) the intensity of the transmitted light corresponding to the at least one time interval.

13. The system of claim 12, wherein the controller is configured to determine the bubble point of the fluid sample by identifying a change within the relative light signal.

14. The system of claim 13, wherein the controller is configured to determine the bubble point of the fluid sample by identifying a corresponding decrease within the transmitted light.

15. The system according to claim 11, further comprising:
a pressure control unit configured to vary pressure of the fluid sample.

16. The system according to claim 11, further comprising:
a microfluidic channel for at least partially containing the fluid sample.

17. The system according to claim 11, further comprising:
a measurement module comprising a detection chamber, the heating element, the source, and the detector;
a reference module comprising a second detector;
a splitter that splits light from a light source; and
a set of optical fibers that provide the light from the splitter to the measurement module and the reference module to determine a transmitted light signal.

18. The system according to claim 17, wherein the controller is configured to compensate a phase change signal from the measurement module using a reference signal from the reference module.

19. A method for determining asphaltene onset pressure of a fluid sample, the method comprising:
transmitting light through the fluid sample;
applying a series of thermal pulses to the fluid sample, wherein the series comprises a time interval between each thermal pulse;
detecting transmitted light;
varying pressure of the fluid sample; and
determining the asphaltene onset pressure by identifying a decrease within an intensity of the transmitted light and using an intensity of the transmitted light corresponding to at least one time interval to exclude a bubble point transition as a cause of the decrease within the intensity of the transmitted light.

20. The method of claim 19, wherein excluding a bubble point transition as a cause of the decrease within the intensity of the transmitted light comprises:
determining a relative light signal using (i) the intensity of the transmitted light corresponding to at least one pulse and (ii) the intensity of the transmitted light corresponding to the at least one time interval; and
identifying a corresponding constant relative light signal.

21. The method of claim 19, further comprising:
decreasing pressure within the fluid sample to determine a lower boundary for asphaltene onset pressure; and
after decreasing pressure within the fluid sample and determining a lower boundary for asphaltene onset pressure, increasing pressure within the fluid sample to determine an upper boundary for asphaltene onset pressure.
